(19) United States
(12) Patent Application Publication
(10) Pub. No.: US 2025/0137095 A1
(43) Pub. Date: May 1, 2025

(54) COPPER ALLOY MATERIAL, PREPARATION METHOD THEREFOR AND USE THEREOF

(71) Applicant: HEBEI LI'EN NEW MATERIAL TECHNOLOGY CO., LTD, Hengshui (CN)

(72) Inventors: Guixiang YANG, Hengshui (CN); Jingzhou YANG, Hengshui (CN); Jinghao YANG, Hengshui (CN); Ming MA, Hengshui (CN); Dongna YANG, Hengshui (CN); Haishen CHEN, Hengshui (CN); Donghua YANG, Hengshui (CN); Xiaofang YU, Hengshui (CN); Mengke WANG, Hengshui (CN)

(73) Assignee: HEBEI LI'EN NEW MATERIAL TECHNOLOGY CO., LTD, Hengshui (CN)

(21) Appl. No.: 18/011,840

(22) PCT Filed: Sep. 3, 2021
(86) PCT No.: PCT/CN2021/116353

§ 371 Date: Oct. 31, 2023

(30) Foreign Application Priority Data
Sep. 8, 2020 (CN) 202010932945.2

(51) Int. Cl. C22C 9/00; B22F 1/065; B22F 9/08; B33Y 70/00; C22C 1/02

(52) U.S. Cl. CPC C22C 9/00; B22F 1/065; B22F 9/082; B33Y 70/00; B22F 2009/0836; B22F 2301/10; C22C 1/02

(57) ABSTRACT

The present disclosure provides a copper alloy material, a preparation method therefor and use thereof, and belong to the technical field of additive manufacturing. The copper alloy material provided by the present disclosure includes the following components by mass percentage: 2.0-7.0% of Cr, 1.0-5.0% of Nb, 0.1-2.0% of Ag, 0.1-0.7% of Zr, 0.02-0.3% of RE, and the balance of Cu. The RE includes the following components by mass percentage: 88-93% of La, 6-9% of Ce, 1.5-1.9% of Pr, and Nd less than or equal to 0.3%, and a sum of mass is 100%. By means of the synergistic effect among RE, Cr, Nb, Ag, Zr and Cu in the present disclosure, thermal conductivity, high-temperature creep property, high-temperature strength, and high-temperature fatigue of the copper alloy material are effectively improved, and the problem of poor high-temperature mechanical properties of a copper alloy material in the prior art is solved.

### CROSS REFERENCE TO RELATED APPLICATION

The present application claims priority to the Chinese Patent Application No. 202010932945.2, filed with the China National Intellectual Property Administration (CNIPA) on Sep. 8, 2020, and entitled “COPPER ALLOY MATERIAL, PREPARATION METHOD THEREFOR AND USE THEREOF”, which is incorporated herein by reference in its entirety.

### TECHNICAL FIELD

The present disclosure belongs to the technical field of additive manufacturing, and in particular, to a copper alloy material, a preparation method therefor and use thereof.

### BACKGROUND ART

Modern aerospace-grade components require high thermal conductivity, high-temperature creep resistance, high-temperature strength, high-temperature fatigue, and high mechanical properties. At present, there are few grades of high-temperature resistant copper alloys that meet the requirements of aerospace-grade components, such as: a CuZr copper alloy whose chemical composition is 0.15-0.3% of Cu—Zr, and a CuAgZr copper alloy whose chemical composition is 3.0% of Cu—Ag and 0.5% of Zr. These high-temperature resistant copper alloy materials are binary alloys or ternary alloys, which are mostly produced by traditional centrifugal casting or forging spinning methods, and are mainly used in the lining of a combustion chamber of a thrust chamber.

However, in the thermal test of the actual hydrogen-oxygen rocket engine, it is often found that the inner wall of the thrust chamber of the hydrogen-oxygen rocket engine has comb-shaped cracks after several hot tests, and the cracks expand slightly in the subsequent hot tests. The inner wall of the channel bulges toward the combustion chamber, the inner wall shows high-temperature creep, and the cooling channel is degraded and fails, which eventually leads to the rupture and damage of the inner wall of the combustion chamber. It can be seen that the existing copper alloy materials have poor high-temperature mechanical properties, which need to be further improved.

### SUMMARY

In view of this, an objective of the present disclosure is to provide a copper alloy material, a preparation method therefor and use thereof. The copper alloy material provided by the present disclosure has excellent high-temperature mechanical properties.

To achieve the above objective of the present disclosure, the present disclosure provides the following technical solutions:

The present disclosure provides a copper alloy material, including the following components by mass percentage:
2.0-7.0% of Cr, 1.0-5.0% of Nb, 0.1-2.0% of Ag, 0.1-0.7% of Zr, 0.02-0.3% of RE, and the balance of Cu.

The RE includes the following components by mass percentage: 88-93% of La, 6-9% of Ce, 1.5-1.9% of Pr, and Nd less than or equal to 0.3%, and a sum of mass is 100%.

Preferably, the copper alloy material may include the following components by mass percentage:
3.0-5.0% of Cr, 1.5-3.5% of Nb, 0.5-1.5% of Ag, 0.2-0.5% of Zr, 0.03-0.2% of RE, and the balance of Cu.

Preferably, the RE may include the following components by mass percentage: 90% of La, 8% of Ce, 1.7% of Pr, and 0.3% of Nd.

The present disclosure further provides a preparation method of the copper alloy material according to the above technical solution, including the following steps:
mixing a Cu source, a Cr source, an Nb source, a Zr source, an Ag source, and an RE source, and conducting vacuum induction melting and casting in sequence to obtain a copper alloy bar, where the RE source contains La, Ce, Pr, and Nd elements;
machining the copper alloy bar to obtain a copper alloy electrode bar; and
conducting plasma spheroidization and rotating electrode atomization under vacuum and a protective atmosphere with the copper alloy electrode bar as an anode to obtain the copper alloy material.

Preferably, a heating process of the vacuum induction melting may include: heating from a room temperature to a first temperature at a first heating rate and holding the first temperature; heating from the first temperature to the second temperature at a second heating rate and holding the second temperature; and heating from the second temperature to a final temperature at a third heating rate.

The room temperature may be heated to the first temperature of 1,200-1,250° C. at the first heating rate of 8-12° C./min and the first temperature is held for 8-10 min.

The first temperature may be heated to the second temperature of 1,280-1,300° C. at the second heating rate of 6-8° C./min and the second temperature is held for 5-8 min.

The second temperature may be heated to the final temperature of 1,500-1,550° C. at the third heating rate of 6-8° C./min.

Preferably, the copper alloy bar may have a diameter of 55-85 mm and a length of 900-1,300 mm.

Preferably, the plasma spheroidization and rotating electrode atomization may be conducted at a plasma arc current intensity of 1,200-1,900 A and a voltage of 35-115 V.

Preferably, the plasma spheroidization and rotating electrode atomization may be conducted at a motor speed of 12,000-18,000 r/min with a plasma torch 2-3 mm from an end face of the copper alloy bar and a feed rate of 0.5-1.0 mm/s.

Preferably, the plasma spheroidization and rotating electrode atomization may be conducted under 0.12-0.16 MPa.

The present disclosure further provides use of the copper alloy material according to the above technical solution or the copper alloy material prepared by the preparation method according to the above technical solution in preparation of a high-temperature resistant part.

The copper alloy material provided by the present disclosure includes the following components by mass percentage: 2.0-7.0% of Cr, 1.0-5.0% of Nb, 0.1-2.0% of Ag, 0.1-0.7% of Zr, 0.02-0.3% of RE, and the balance of Cu. The RE includes the following components by mass percentage: 88-93% of La, 6-9% of Ce, 1.5-1.9% of Pr, and Nd less than or equal to 0.3%, and a sum of mass is 100%. In the present disclosure, Cu is used as a matrix metal, such that the copper alloy has excellent high-temperature mechanical properties, and Cr and Ag play a role in solid solution strengthening of the copper alloy, which can further improve the high-temperature mechanical properties of the copper alloy material. By means of the synergistic effect among Cr, Ag, Cu, Nb, Zr, and RE in the copper alloy material, thermal conductivity, high-temperature creep property, high-temperature strength, and high-temperature fatigue of the copper alloy material can be effectively improved, and the problem of poor high-temperature mechanical properties of a copper alloy material in the prior art is solved.

### BRIEF DESCRIPTION OF THE DRAWINGS

FIG. 1 is an optical microscope photograph of a copper alloy material prepared in Example 1.

### DETAILED DESCRIPTION OF THE EMBODIMENTS

The present disclosure provides a copper alloy material, including the following components by mass percentage:
2.0-7.0% of Cr, 1.0-5.0% of Nb, 0.1-2.0% of Ag, 0.1-0.7% of Zr, 0.02-0.3% of RE, and the balance of Cu.

In the present disclosure, the copper alloy material provided by the present disclosure includes 2.0-7.0% of Cr by mass percentage, preferably 3.0-5.0%, and further preferably 4.0%. In the present disclosure, Cr can play a role in solid solution strengthening of Cu, improve the high-temperature strength, high wear resistance and corrosion resistance of the copper alloy material, and refine grains of the prepared copper alloy.

The copper alloy material provided by the present disclosure includes 1.0-5.0% of Nb by mass percentage, preferably 1.5-3.5%, and further preferably 2.0%. In the present disclosure, Nb can effectively improve high-temperature strength, high-temperature creep resistance, high-temperature fatigue, and thermal conductivity of the copper alloy material.

The copper alloy material provided by the present disclosure includes 0.1-2.0% of Ag by mass percentage, preferably 0.5-1.5%, and further preferably 1.0%. In the present disclosure, Ag can play a role of solid solution strengthening and improve the high-temperature strength, electrical conductivity, recrystallization temperature, high-temperature creep, and high-temperature fatigue resistance of the copper alloy material.

The copper alloy material provided by the present disclosure includes 0.1-0.7% of Zr by mass percentage, preferably 0.2-0.5%, and further preferably 0.4%. In the present disclosure, Zr can effectively improve the recrystallization temperature and high-temperature strength of the copper alloy material. In the present disclosure, the content of Zr can inhibit the growth of the Cr phase, thereby ensuring a small grain size in the prepared copper alloy material, and effectively improving the mechanical properties and electrical conductivity of the copper alloy material.

The copper alloy material provided by the present disclosure includes 0.02-0.3% of RE by mass percentage, preferably 0.05-0.2%, and further preferably 0.07-0.15%. In the present disclosure, the RE includes the following components by mass percentage: 88-93% of La, 6-9% of Ce, 1.5-1.9% of Pr, and Nd less than or equal to 0.3%, with a sum of mass being 100%, and preferably includes 90% of La, 8% of Ce, 1.7% of Pr, and 0.3% of Nd. In the present disclosure, RE can form a high melting point mesophase (CuRE) with the Cu matrix, form a large number of non-uniform nucleation particles, and increase the nucleation rate, such that the metallographic grains of the prepared copper alloy material are refined, uniform and dense, and the chemical properties of rare earth elements are extremely active and have strong reducibility. During smelting, it can preferentially undergo redox reactions with elements such as O, P, and S contained in the alloy to form high melting point compounds (PrP, CeO₂, CeS, and La₂S₃), and the high melting point compounds enter the slag to improve the high-temperature strength and electrical conductivity of the copper alloy material.

The copper alloy material provided by the present disclosure includes the balance of copper. In the present disclosure, Cu has high thermal conductivity, excellent creep properties and high-temperature strength.

The present disclosure further provides a preparation method of the copper alloy material according to the above technical solution, including the following steps.

A Cu source, a Cr source, an Nb source, a Zr source, an Ag source, and an RE source are mixed, and vacuum induction melting and casting are conducted in sequence to obtain a copper alloy bar.

The copper alloy bar is machined to obtain a copper alloy electrode bar.

Plasma spheroidization and rotating electrode atomization is conducted under vacuum and a protective atmosphere with the copper alloy electrode bar as an anode to obtain the copper alloy material.

The present disclosure mixes a Cu source, a Cr source, an Nb source, a Zr source, an Ag source, and an RE source, and conducts vacuum induction melting and casting in sequence to obtain a copper alloy bar.

In the present disclosure, the Cu source is preferably electrolytic copper. The present disclosure has no special limitation on the source of the electrolytic copper, and any conventional commercial product in the art or a product prepared by an electrolytic method well known to those skilled in the art can be used. In the present disclosure, the source of the Cr source is preferably a CuCr alloy, and the CuCr alloy preferably contains the following components by mass percentage: 70% of Cu and 30% of Cr. In the present disclosure, the source of the Nb source is preferably a CuNb alloy, and the CuNb alloy preferably contains the following components by mass percentage: 80% of Cu and 20% of Nb. In the present disclosure, the source of the Zr source is preferably a CuZr alloy, and the CuZr alloy preferably contains the following components by mass percentage: 85% of Cu and 15% of Zr. In the present disclosure, the source of the Ag source is preferably industrial Ag. In the present disclosure, the source of the RE source is preferably an RE alloy. The RE alloy includes the following components by mass percentage: 88-93% of La, 6-9% of Ce, 1.5-1.9% of Pr, and Nd less than or equal to 0.3%, with a sum of mass being 100%. The present disclosure has no special limitation on the source of the RE alloy, and any conventional commercial product in the art or a product prepared by a method well known to those skilled in the art can be used.

In the present disclosure, the Cr source, the Nb source, and the Zr source are added in forms of a CuCr alloy, a CuNb alloy, and a CuZr alloy, so as to avoid the serious burning loss of metal elements Cr, Nb and Zr during high-temperature smelting, resulting in defects such as inclusions polluting the alloy liquid, such that the prepared copper alloy material has high purity, no impurities, uniform and dense metallographic structure, and high comprehensive mechanical properties. The prepared copper alloy material can meet the requirements of aerospace-grade application standards.

In the present disclosure, the mixing is preferably conducted in a vacuum induction furnace. The present disclosure has no special limit on the mixing method, and a mixing method well known to those skilled in the art can be used. The present disclosure preferably vacuumizes the vacuum induction furnace till a vacuum degree of 0.01 Pa, and introduces an inert gas. The inert gas is preferably a mixed gas of argon and helium, and the argon and the helium has a volume ratio of preferably 1:1.

In the present disclosure, a heating process of the vacuum induction melting preferably includes: heating from a room temperature to a first temperature at a first heating rate and holding the first temperature; heating from the first temperature to the second temperature at a second heating rate and holding the second temperature; and heating from the second temperature to a final temperature at a third heating rate. The room temperature is heated to the first temperature of 1,200-1,250° C., further preferably 1,220-1,240° C., at the first heating rate of 8-12° C./min, further preferably 10° C./min, and the first temperature is held for 8-10 min, further preferably 9 min. The first temperature is heated to the second temperature of 1,280-1,300° C., further preferably 1,290° C., at the second heating rate of 6-8° C./min, further preferably 7° C./min, and the second temperature is held for 5-8 min, further preferably 6 min. The second temperature is heated to the final temperature of 1,500-1,550° C., further preferably 1,520-1,530° C. at the third heating rate of 6-8° C./min, further preferably 7° C./min.

In the present disclosure, preferably, casting is conducted directly when the temperature of the vacuum induction melting reaches the final temperature. The present disclosure has no special limit on the casting method, and a casting method well known to those skilled in the art can be used.

In the present disclosure, the copper alloy bar has a diameter of preferably 55-85 mm and a length of preferably 900-1,300 mm.

After the copper alloy bar is obtained, the present disclosure machines the copper alloy bar to obtain a copper alloy electrode bar.

In the present disclosure, the machining method is preferably to conduct turning, rough polishing and fine polishing of the copper alloy electrode bar in sequence. In the present disclosure, a depth of the turning may be preferably 1-2 mm. The present disclosure has no special limit on the rough polishing and fine polishing method, and a rough polishing and fine polishing method well known to those skilled in the art can be used.

After the copper alloy electrode bar is obtained, the present disclosure conducts plasma spheroidization and rotating electrode atomization under vacuum and a protective atmosphere with the copper alloy electrode bar as an anode to obtain the copper alloy material.

In the present disclosure, the plasma spheroidization and rotating electrode atomization is conducted in an atomizing device. The present disclosure preferably vacuumizes an atomizing chamber of the atomizing device till a vacuum degree of 10×10−3 Pa, and introduces an inert gas. In the present disclosure, the inert gas is preferably a mixed gas of argon and helium, and the argon and the helium has a volume ratio of preferably 1:1.

In the present disclosure, the plasma spheroidization and rotating electrode atomization is conducted at a plasma arc current intensity of 1,200-1,900 A, further preferably 1,500 A, and a voltage of 35-115 V, further preferably 70 V. The plasma spheroidization and rotating electrode atomization is conducted at a motor speed of 12,000-18,000 r/min, further preferably 15,000 r/min, with a plasma torch preferably 2-3 mm from an end face of the copper alloy bar and a feed rate of 0.5-1.0 mm/s. In the present disclosure, the plasma torch is preferably used to heat and melt the end face of the copper alloy bar rotating at a high speed, and the molten droplets are centrifuged and condensed into spherical copper alloy material powder in the atomizing chamber. The present disclosure utilizes the plasma spheroidization and rotating electrode atomization process to prepare the copper alloy material with high sphericity, high purity, excellent fluidity, low oxygen content, and uniform composition.

In the present disclosure, the pressure in the atomizing chamber is preferably 0.12-0.16 MPa, which can prevent the atmosphere from entering the atomizing chamber, and maintain the vacuum degree, facilitating the control of the gas flow direction and the cooling of the spherical powder.

After the plasma spheroidization and rotating electrode atomization, the present disclosure preferably cools, sieves and vacuum packs the spherical copper alloy powder obtained by the plasma spheroidization and rotating electrode atomization in sequence to obtain the copper alloy material. The present disclosure has no special limit on the cooling method, and a cooling method well known to those skilled in the art can be used. The present disclosure has no special limit on the sieving method, and a sieving method well known to those skilled in the art can be used.

In the present disclosure, the copper alloy material has a particle size of preferably 15-45 μm, a sphericity rate of preferably 99.90-99.96%, an oxygen content of preferably 35-40 ppm, an apparent density of preferably 5.0-5.5 g/cm³, a tap density of preferably 6.4-6.6 g/cm³, and a fluidity of preferably 5 s/50 g.

The present disclosure further provides use of the copper alloy material according to the above technical solution or the copper alloy material prepared by the preparation method according to the above technical solution in preparation of a high-temperature resistant part.

In the present disclosure, the copper alloy material is preferably suitable for use in gas turbine engines, aerodynamic heating devices, steam turbine power and high pressure steam equipment, aerospace engines or petrochemical high-temperature equipment.

In the present disclosure, use method is preferably as follows: 3D printing the copper alloy material in FS421M industrial-grade metal additive manufacturing (3D printing) equipment to obtain the high-temperature resistant part.

The copper alloy material provided by the present disclosure has small particle size, narrow particle size distribution of 20-30 μm, low oxygen content, little/no spheroidization during additive manufacturing, and no agglomeration, and the consistency and uniformity of additive manufacturing are fully guaranteed. In addition, the copper alloy material has high sphericity, excellent fluidity, high loose density, and excellent powder spreading uniformity. The products obtained by additive manufacturing have uniform and dense metallographic structure and excellent high-temperature mechanical properties, which can meet the standard requirements for industrial-grade and scientific-grade metal additive manufacturing (3D printing) equipment to print aerospace-grade parts with complex structures and high mechanical properties.

The copper alloy material, the preparation method therefor and the use thereof provided by the present disclosure will be described in detail in connection with the following examples, but they should not be construed as limiting the protection scope of the present disclosure.

### Examples 1 to 8

According to the mass percentage of each metal element in the copper alloy material (see Table 1 for the specific content), electrolytic copper powder, CuCr alloy powder (Cu 70%-Cr 30%), CuNb alloy powder (Cu 80%-Nb 20%), CuZr alloy powder (Cu 85%-Zr 15%), industrial pure Ag powder, and RE alloy powder (La 90%-Ce 8%-Pr 1.7%-Nd 0.3%) were weighed, and added into a vacuum induction furnace.

After the vacuum induction furnace was vacuumized to 0.01 Pa, an inert gas (a mixed gas of argon and helium with a volume ratio of 1:1) was introduced. A room temperature was heated to 1,250° C. at 10° C./min and held for 10 min. The temperature was heated from 1,250° C. to 1,300° C. at 7° C./min and held for 8 min. The temperature was heated from 1,300° C. to 1,550° C. at 7° C./min. Vacuum induction melting was conducted to obtain molten liquid, and the molten liquid was casted to obtain a copper alloy bar with a diameter of 55-85 mm and a length of 900-1,300 mm.

The prepared copper alloy bar was turned with a lathe to remove the skin of the copper alloy bar with a depth of 1-2 mm, and subjected to rough polishing and fine polishing in sequence to obtain a copper alloy bar.

The prepared copper alloy bar was placed in an atomizing device as an anode. An atomizing chamber was vacuumized to a vacuum degree of 10×10⁻³, and an inert gas (a mixed gas of argon and helium with a volume ratio of 1:1) was introduced. Plasma spheroidization and rotating electrode atomization was conducted at a plasma arc current intensity of 1,900 A and a voltage of 115 V, a motor speed of 18,000 r/min with a plasma torch 3 mm from an end face of the bar and a feed rate of 1.0 mm/s. The pressure in the atomizing chamber was 0.16 MPa, and the copper alloy material was obtained.

### Comparative Example

The preparation method in this comparative example is the same as that in Example 1, the only difference is that the mass percentage of each metal element in the copper alloy material is different, and the copper alloy material does not contain rare earth. The specific content is shown in Table 1.

TABLE 1
Mass percentage of each metal element in copper alloy
material in Examples 1 to 8 and Comparative Example

| | Metal element contents % | | | | | |
|---|---|---|---|---|---|---|
| Sample | Cr | Nb | Ag | Zr | RE | The balance of Cu |
| Example 1 | 6.5 | 4.5 | 1.5 | 0.6 | 0.02 | the balance |
| Example 2 | 6.0 | 4.0 | 0.5 | 0.5 | 0.3 | the balance |
| Example 3 | 5.5 | 3.5 | 0.3 | 0.3 | 0.07 | the balance |
| Example 4 | 5.0 | 3.0 | 0.4 | 0.2 | 0.1 | the balance |
| Example 5 | 4.5 | 2.5 | 0.2 | 0.1 | 0.2 | the balance |
| Example 6 | 4.2 | 2.2 | 0.1 | 0.1 | 0.15 | the balance |
| Example 7 | 3.0 | 1.5 | 0.6 | 0.2 | 0.05 | the balance |
| Example 8 | 2.0 | 1.0 | 1.1 | 0.4 | 0.06 | the balance |
| Comparative | 7.0 | 5.0 | 2.0 | 0.7 | 0 | the balance |
| Example | | | | | | |

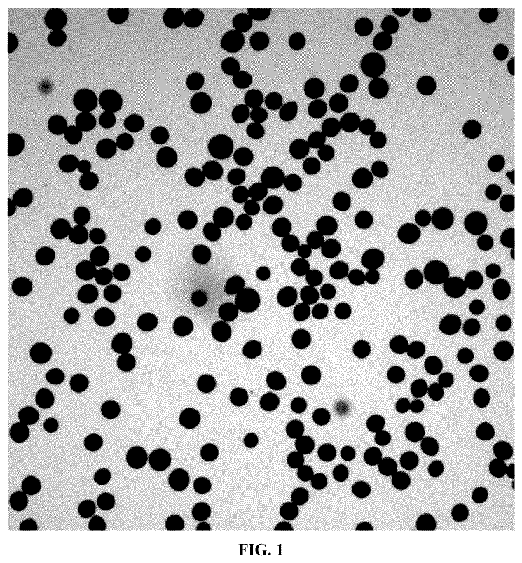

FIG. 1 is an optical microscope photograph of a copper alloy material prepared in Example 1, in which the scale size is 50 μm. It can be seen from the FIGURE that the particles of the copper alloy material have high surface cleanliness without hollow powder and satellite powder, and have high sphericity of 99.94%, and the spherical powder has uniform composition, an oxygen content of 35 ppm, an apparent density of 5.2 g/cm³, a tap density of 6.4 g/cm³, and a fluidity of 5 s/50 g.

### High-Temperature Tensile Mechanical Property Test

The copper alloy materials prepared in Examples 1 to 8 and Comparative Example and the conventional commercially available Cu—Ag3.0-Zr0.5 (CuAgZr) copper alloy materials were printed using FS421M additive manufacturing (3D printing) equipment and a printed part was tested for high-temperature tensile mechanical property.

The high-temperature tensile mechanical property test standard was: GB/T4338-2006 “Metallic materials-Tensile testing at elevated temperature”. Standard high-temperature tensile samples were printed, and standard tensile samples were obtained after post-processing. The tensile test was conducted on the ETM4504GD metal material high and low temperature tensile testing machine. The samples were stretched under the parameters of a temperature of 785 K and a strain rate of 5 mm/min respectively. The test results are shown in Table 2.

### Electrical Conductivity Test

The electrical conductivity test standard was GB/T32791-2016 “Electromagnetic (eddy-current) examination method for electrical conductivity of copper and copper alloys”, and the standard samples of Examples 1 to 8 and Comparative Example and a CuAgZr alloy were prepared. A test surface was flat, and the sample had surface roughness less than 5 μm. Rough polishing and fine polishing were conducted in sequence with 800 and 1200 grit sandpaper. The Sigma2008A eddy current conductivity meter was used to test the samples. The ambient temperature was in the range of 18-22° C., and the temperature of the probe, the instrument, the standard test block and the sample were all consistent. The instrument was started and calibrated. The probe surface was parallel and close to the test surface. The probe was more than 5 mm away from the edge of the test surface. 3 detection parts were selected for each sample for test, and an average value was taken as the final detection result.

TABLE 2
Test results of high-temperature tensile mechanical
property and electrical conductivity of Examples
1 to 8, Comparative Example, and CuAgZr alloy

| | Tensile | Yield | Elongation | | Electric |
|---|---|---|---|---|---|
| | strength | strength | after | Reduction | conductivity/% |
| Sample | MPa | MPa | fracture % | of area % | IACS |
| CuAgZr | 351 | 326 | 14.1 | 52.6 | 88.6 |
| Example 1 | 361 | 339 | 15.1 | 57.3 | 89.2 |
| Example 2 | 356 | 334 | 14.2 | 56.6 | 88.7 |
| Example 3 | 407 | 381 | 20.2 | 64.6 | 93.3 |
| Example 4 | 410 | 386 | 20.3 | 65.2 | 93.8 |
| Example 5 | 418 | 395 | 22.8 | 66.5 | 94.5 |
| Example 6 | 420 | 396 | 22.9 | 67.1 | 96.3 |
| Example 7 | 405 | 380 | 20.2 | 64.3 | 93.8 |
| Example 8 | 403 | 379 | 19.9 | 64.1 | 93.6 |
| Comparative | 358 | 336 | 14.7 | 56.8 | 88.8 |
| Example | | | | | |

It can be seen from the above experimental data that the high-temperature tensile mechanical property of the samples of Comparative Example and Examples 1 to 2 is slightly higher than that of the CuAgZr alloy. The high-temperature tensile mechanical property of the samples of Examples 3 to 8 is significantly improved compared with that of the CuAgZr alloy and the samples of Examples 1 to 2. It is indicated that the content of each metal component in the copper alloy material provided by the present disclosure can significantly improve the high-temperature mechanical property of the copper alloy material.

The electrical conductivity of the samples of Comparative Example and Examples 1 to 2 is basically the same as that of the CuAgZr alloy. Under the same test conditions, the electrical conductivity of the samples of Examples 3 to 8 is significantly improved.

### High-Temperature Fatigue Property Test

The high-temperature fatigue test standard was HB7680-2019 “Testing Method for Crack Propagation Rate of Metal Material Under High Temperature Fatigue”. The FS421M metal additive manufacturing (3D printing) equipment was used to print and prepare samples meeting the requirements of the high-temperature fatigue test standard.

The high-temperature fatigue property of the samples prepared in Example 6 and the CuAgZr alloy were compared. The test was conducted on the FLPL105G metal material high-temperature fatigue testing machine in a temperature range of 650-850 K at a frequency of 95 Hz. The stress ratio of tensile loading was R=0.1. In the laboratory static environment, the fatigue life under different temperatures and different stresses was measured.

A (1) A stress of 150 MPa was selected, and temperatures of 650 K, 700 K, 750 K, 850 K were selected under the same step temperature to compare the fatigue life of both alloys. After testing, it was known that the fatigue life of the samples prepared in Example 6 was higher than that of the control alloy in varying degrees, for example, 49.6% higher than that of the control alloy at 850 K, 61% higher at 750 K, 63% higher at 700 K, and 65% higher at 650 K, indicating that under the same conditions of stress and temperature of the two alloys, the high-temperature cyclic fatigue life of the copper alloy material provided by the present disclosure was obviously longer than that of the CuAgZr alloy. The test results are shown in Table 3.

A (2) A stress of 250 MPa was selected, and temperatures of 650 K, 700 K, 750 K, 850 K were selected under the same step temperature. With the increase of stress, the fatigue life of both alloys decreased in varying degrees. The fatigue life of both alloys was compared. After testing, it was known that the fatigue life of the samples prepared in Example 6 was higher than that of the CuAgZr alloy in varying degrees, for example, 30% higher than that of the control alloy at 850 K, 45% higher at 750 K, 47% higher at 700 K, and 53% higher at 650 K. The test showed that the fatigue life of the copper alloy material provided by the present disclosure was obviously longer than that of the CuAgZr alloy. The test results are shown in Table 4.

TABLE 3
Results of high-temperature fatigue property test

| | | Maxi- | Maxi- | Mini- | | |
|---|---|---|---|---|---|---|
| | Temper- | mum | mum | mum | Fre- | |
| | ature | stress | load | load | quency | Life Nf |
| Sample | K | MPa | KN | KN | Hz | cycles |
| CuAgZr | 650 | 150 | 4.51 | 0.459 | 93.7 | 9100000 |
| | 700 | 150 | 4.47 | 0.46 | 93.9 | 4832507 |
| | 750 | 150 | 4.43 | 0.45 | 89.7 | 531629 |
| | 850 | 150 | 4.2 | 0.42 | 89.4 | 41566 |
| Example | 650 | 150 | 4.52 | 0.46 | 94.3 | 15015000 |
| 6 | 700 | 150 | 4.50 | 0.45 | 94.2 | 7876986 |
| | 750 | 150 | 4.51 | 0.44 | 90.9 | 855000 |
| | 850 | 150 | 4.35 | 0.43 | 90.7 | 62200 |

TABLE 4
Results of high-temperature fatigue property test

| | | Maxi- | Maxi- | Mini- | | |
|---|---|---|---|---|---|---|
| | Temper- | mum | mum | mum | Fre- | |
| | ature | stress | load | load | quency | Life Nf |
| Sample | K | MPa | KN | KN | Hz | cycles |
| CuAgZr | 650 | 250 | 7.15 | 0.72 | 94 | 1901210 |
| | 700 | 250 | 7.20 | 0.73 | 100 | 96112 |
| | 750 | 250 | 7.04 | 0.71 | 95.3 | 14110 |
| | 850 | 250 | 6.63 | 0.66 | 90.7 | 6120 |
| Example | 650 | 250 | 7.16 | 0.73 | 94.3 | 2908821 |
| 6 | 700 | 250 | 7.22 | 0.74 | 103 | 141284 |
| | 750 | 250 | 7.08 | 0.72 | 95.3 | 20459 |
| | 850 | 250 | 6.65 | 0.66 | 91.2 | 7956 |

### High-Temperature Creep Property Test

The high-temperature creep property test standard was HB5151-96 “Method of Tensile Creep Test for Metal at High Temperature”. The FS421M additive manufacturing (3D printing) equipment was used to print samples meeting the requirements of the high-temperature creep test standard.

The samples were respectively subjected to high-temperature creep test on the RC-1130 (425A) type high-temperature creep testing machine in a temperature range of 600-900 K and a load range of 50-270 MPa. The strain amount of the creep sample at different times was recorded. After the testing machine was heated to a specified temperature, the samples were loaded. After the specified temperature was reached and held for 8-10 min, the high-temperature creep test was conducted. The tensile time of the creep test was set to 1 h, and each sample was tested for 1 h and taken out for cooling. The creep rates of the samples at different stress levels at temperatures of 600 K, 700 K, 800 K, and 900 K were recorded. At the same temperature, with the increase of stress, the initial strain and initial creep rate gradually increased. It could be known from the test results that the initial strain and initial creep rate of the samples prepared in Example 6 of the present disclosure were less than those of the CuAgZr alloy. Under the same temperature and the same stress (both at 240 MPa), within the specified high-temperature creep time, the total strain of the samples prepared in Example 6 was 0.561%, while the total strain of the CuAgZr alloy reached 0.98%, which was 74.68% higher than that of the samples prepared in Example 6. The test showed that the high-temperature creep resistance of the copper alloy material provided by the present disclosure was obviously higher than that of the CuAgZr alloy. The test results are shown in Table 5.

TABLE 5
Results of high-temperature creep property test

| | | | Initial | Total | |
|---|---|---|---|---|---|
| Sample | Temperature k | Stress MPa | strain % | strain % | Duration h |
| CuAgZr | 600 | 260 | 0.375 | 0.43 | 1 |
| | 700 | 240 | 0.331 | 0.980 | 1 |
| | 800 | 120 | 0.212 | 0.394 | 1 |
| | 900 | 50 | 0.151 | 0.261 | 1 |
| Example 6 | 600 | 270 | 0.311 | 0.357 | 1 |
| | 700 | 240 | 0.301 | 0.561 | 1 |
| | 800 | 120 | 0.15 | 0.273 | 1 |
| | 900 | 50 | 0.081 | 0.139 | 1 |

### Corrosion Resistance Test

The FS421M additive manufacturing (3D printing) equipment was used to print samples meeting the requirements of corrosion resistance test standards. The samples had a size of 20 mm×20 mm×20 mm, and were soaked in a mixture of 0.1 mol/L HCl+0.1 mol/L H₂O₂ after grinding, polishing, cleaning and drying and weighed regularly. A mass loss rate was calculated, and a new corrosive solution was replaced. After corrosion by an FeCl₃ alcohol solution, cleaning and drying, the samples were placed under a microscope to measure a corrosion depth. According to a weight loss rate and an average corrosion depth, the corrosion resistance of the samples was compared.

There was no significant difference in the corrosion resistance between the samples of Comparative Example and Examples 1 to 2 and the CuAgZr alloy, and the corrosion resistance of the samples of Examples 3 to 8 was significantly improved, which was obviously more excellent than that of the CuAgZr alloy and the samples of Comparative Example and Examples 1 to 2. The test results are shown in Table 6.

### Wear Resistance Test

The FS421M additive manufacturing (3D printing) equipment was used to prepare samples.

The samples had a size of 10 mm×10 mm×20 mm. The alloy of the present disclosure and the CuAgZr alloy samples were subjected to the wear resistance test on the M200 wear tester. The grinding wheel (friction pair) was made of GCr steel, and the sample and the friction pair had surface roughness of both 1.61. The test showed that under the friction condition of 20 kg load and oil lubrication, the running-in mileage of each sample was basically the same, namely 0.2 km, and the mileage of each sample was taken as 1.5 km for the comparative wear test.

There was no significant difference in wear resistance between the samples of Comparative Example and Examples 1 to 2 and the CuAgZr alloy. The wear resistance of the samples of Examples 3 to 8 was significantly improved, which was obviously more excellent than that of the CuAgZr alloy and the samples of Comparative Example and Examples 1 to 2. The test results are shown in Table 6.

TABLE 6
Results of corrosion resistance and wear resistance test

| | Average corrosion | | |
|---|---|---|---|
| Sample | depth μm | Weight loss rate % | Wear loss mm³ |
| CuAgZr | >3.5 | 0.52 | 0.351 |
| Example 1 | >3.0 | 0.46 | 0.291 |
| Example 2 | >3.3 | 0.48 | 0.301 |
| Example 3 | <1 | 0.12 | 0.081 |
| Example 4 | <0.9 | 0.12 | 0.080 |
| Example 5 | <0.8 | 0.1 | 0.067 |
| Example 6 | <0.7 | 0.1 | 0.060 |
| Example 7 | <0.9 | 0.11 | 0.069 |
| Example 8 | <1 | 0.13 | 0.081 |
| Comparative | >3.2 | 0.44 | 0.297 |
| Example | | | |

The above descriptions are merely preferred implementations of the present disclosure. It should be noted that those of ordinary skill in the art may further make several improvements and modifications without departing from the principle of the present disclosure, but such improvements and modifications should be deemed as falling within the protection scope of the present disclosure.

What is claimed is:

1. A copper alloy material, comprising the following components by mass percentage:
2.0-7.0% of Cr, 1.0-5.0% of Nb, 0.1-2.0% of Ag, 0.1-0.7% of Zr, 0.02-0.3% of RE, and the balance of Cu, wherein
the RE comprises the following components by mass percentage: 88-93% of La, 6-9% of Ce, 1.5-1.9% of Pr, and Nd less than or equal to 0.3%, and a sum of mass is 100%.

2. The copper alloy material according to claim 1, comprising the following components by mass percentage:
3.0-5.0% of Cr, 1.5-3.5% of Nb, 0.1-2.0% of Ag, 0.1-0.7% of Zr, 0.02-0.3% of RE, and the balance of Cu.

3. The copper alloy material according to claim 2, comprising the following components by mass percentage:
3.0-5.0% of Cr, 1.5-3.5% of Nb, 0.5-1.5% of Ag, 0.2-0.5% of Zr, 0.03-0.2% of RE, and the balance of Cu.

4. The copper alloy material according to claim 1 or 2 or 3, wherein the RE comprises the following components by mass percentage: 90% of La, 8% of Ce, 1.7% of Pr, and 0.3% of Nd.

5. A preparation method of the copper alloy material according to any one of claims 1 to 4, comprising the following steps:
mixing a Cu source, a Cr source, an Nb source, a Zr source, an Ag source, and an RE source, and conducting vacuum induction melting and casting in sequence to obtain a copper alloy bar, wherein the RE source contains La, Ce, Pr, and Nd elements;
machining the copper alloy bar to obtain a copper alloy electrode bar; and
conducting plasma spheroidization and rotating electrode atomization under vacuum and a protective atmosphere with the copper alloy electrode bar as an anode to obtain the copper alloy material.

6. The preparation method according to claim 5, wherein the Cr source, the Nb source, and the Zr source are added in forms of a CuCr alloy, a CuNb alloy, and a CuZr alloy.

7. The preparation method according to claim 5, wherein a heating process of the vacuum induction melting comprises: heating from a room temperature to a first temperature at a first heating rate and holding the first temperature: heating from the first temperature to the second temperature at a second heating rate and holding the second temperature; and heating from the second temperature to a final temperature at a third heating rate:
the room temperature is heated to the first temperature of 1,200-1,250° C. at the first heating rate of 8-12° C./min and the first temperature is held for 8-10 min;
the first temperature is heated to the second temperature of 1,280-1,300° C. at the second heating rate of 6-8° C./min and the second temperature is held for 5-8 min; and
the second temperature is heated to the final temperature of 1,500-1,550° C. at the third heating rate of 6-8° C./min.

8. The preparation method according to claim 5, wherein the copper alloy bar has a diameter of 55-85 mm and a length of 900-1,300 mm.

9. The preparation method according to claim 5, wherein the plasma spheroidization and rotating electrode atomization is conducted at a plasma arc current intensity of 1,200-1,900 A and a voltage of 35-115 V.

10. The preparation method according to claim 5 or 9, wherein the plasma spheroidization and rotating electrode atomization is conducted at a motor speed of 12,000-18,000 r/min with a plasma torch 2-3 mm from an end face of the copper alloy bar and a feed rate of 0.5-1.0 mm/s.

11. The preparation method according to claim 5, wherein the plasma spheroidization and rotating electrode atomization is conducted under 0.12-0.16 MPa.

12. Use of the copper alloy material according to any one of claims 1 to 4 or the copper alloy material prepared by the preparation method according to any one of claims 5 to 11 in preparation of a high-temperature resistant part.

13. The use according to claim 12, comprising the following step: 3D printing the copper alloy material in FS421M industrial-grade metal additive manufacturing equipment to obtain the high-temperature resistant part.
